(19) United States
(12) Patent Application Publication
(10) Pub. No.: US 2009/0125880 A1
(43) Pub. Date: May 14, 2009

(54) POLYMORPHIC SOFTWARE ARCHITECTURE

(75) Inventors: Dragos A. Manolescu, Kirkland, WA (US); Erik Meijer, Mercer Island, WA (US)

Correspondence Address: MICROSOFT CORPORATION, ONE MICROSOFT WAY, REDMOND, WA, 98052, US

(73) Assignee: Microsoft Corporation, Redmond, WA (US)

(21) Appl. No.: 11/938,373

(22) Filed: Nov. 12, 2007

(51) Int. Cl. G06F 9/44

(52) U.S. Cl. 717/110

(57) ABSTRACT

A polymorphic software architecture is provided by which the shape of the architecture is enabled to be dynamically changed by splitting and fusing various architectural components (which may also be called “elements”) responsively to the environment in which the software executes, without changing the application's code. The splitting and fusing points determine, for example, the partitioning of functionality and data across architecture components, communication among the components, and the allocation of resources to the components. A profile of an end-user, or a profile of the runtime environment that supports the end-user, may be used to drive the shape of the software architecture so that overall design goals are met upon initial software deployment, and maintained as the profiles change.

### BACKGROUND

Software architecture generally prescribes the structures of a system used in a computing environment and the ways they interact with each other. Architecture focuses on how a system's functionality and data are partitioned, and the communication between the partitioned components in order to meet the overall design goals and objectives of the system. Software architecture provides a degree of abstraction and an organizational framework for the underlying functionality and features provided by software code which can generally be complex.

Adding to the complexity of today's computing environments is the trend in which programming is distributed over a multiplicity of platforms that typically: have their own programming languages, libraries and tools; employ different programming paradigms; and use different programming models in order to support a particular user experience. Software developers are faced with the challenge of designing software architectures that are responsive to such environments and which meet users' expectations. For example, under a “software as services” model, Web services may be used to complement, or even replace in some cases, traditional client or host-based computing. Accordingly, new software architecture solutions that provide for rich user experiences while meeting design goals in a practical and optimized manner are generally desirable. However, once fixed, reshaping an architecture (i.e., reallocating the partitioning of functionality and data) is prohibitively expensive since it transcends multiple platforms, languages, paradigms, and models. Consequently changing the structure is uncommon and typically it remains fixed, even when run time metrics suggest a different partitioning.

This Background is provided to introduce a brief context for the Summary and Detailed Description that follow. This Background is not intended to be an aid in determining the scope of the claimed subject matter nor be viewed as limiting the claimed subject matter to implementations that solve any or all of the disadvantages or problems presented above.

### SUMMARY

A polymorphic software architecture is provided by which the shape of the architecture is enabled to be dynamically changed by splitting and fusing various architectural components responsively to the environment in which the software executes. The splitting and fusing points determine, for example, the partitioning of functionality and data across architecture components, communication among the components, and the allocation of resources to the components. A profile of a user, or a profile of the runtime environment that supports the user, may be used to drive the shape of the software architecture so that overall design goals are met upon initial software deployment, and maintained as the profiles change during runtime.

The present polymorphic software architecture advantageously enables decisions about how a particular software solution is architected to be flexibly made, such as being delayed to the point of the software's runtime. Because software architecture fundamentally drives key quality and design goals, being able to shape the architecture at a point in time later than the early design stage, when little is known about the communication patterns and volumes between the architectural elements, can generate better optimized solutions.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### DESCRIPTION OF THE DRAWINGS

FIG. 1 shows an illustrative environment in which the present polymorphic software architecture may be applied;

FIG. 2 shows an illustrative software architecture that comprises a multiplicity of components which are functionally connected;

FIG. 3 is a screen shot of a first illustrative user interface by which an end-user may select an architecture component;

FIG. 4 is a screen shot of a second illustrative user interface by which an end-user may select an architecture component;

FIG. 5A shows an illustrative polymorphic architecture shape that is applicable to a client-server arrangement when the client is a thick client;

FIG. 5B shows an illustrative polymorphic architecture shape that is applicable to a client-server arrangement when the client is a thin client;

FIG. 6A shows an illustrative polymorphic architecture shape that is applicable to a computer arrangement that has a relatively large display screen;

FIG. 6B shows an illustrative polymorphic architecture shape that is applicable to a computer arrangement that has a relatively small display screen;

FIG. 7A shows an illustrative polymorphic architecture shape that is applicable to a client-server arrangement when the client operates in a secure environment;

FIG. 7B shows an illustrative polymorphic architecture shape that is applicable to a client-server arrangement when the client operates in a non-secure environment such as an Internet cafe or library;

FIG. 8A shows an illustrative polymorphic architecture shape that is applicable to a client-server arrangement when the server operates in an environment having normal server load and/or normal levels of network latency and throughput;

FIG. 8B shows an illustrative polymorphic architecture shape that is applicable to a client-server arrangement when the server operates in an environment having high server load and/or high levels of network degradation;

FIG. 9A shows an illustrative polymorphic architecture shape that is applicable to a client-server arrangement when software is used on a trial basis and/or by a user having relatively fewer privileges according to a user profile; and

FIG. 9B shows an illustrative polymorphic architecture shape that is applicable to a client-server arrangement when software is used on a fully paid basis and/or by a user having relatively greater privileges according to a user profile.

Like reference numerals indicate like elements in the drawings.

### DETAILED DESCRIPTION

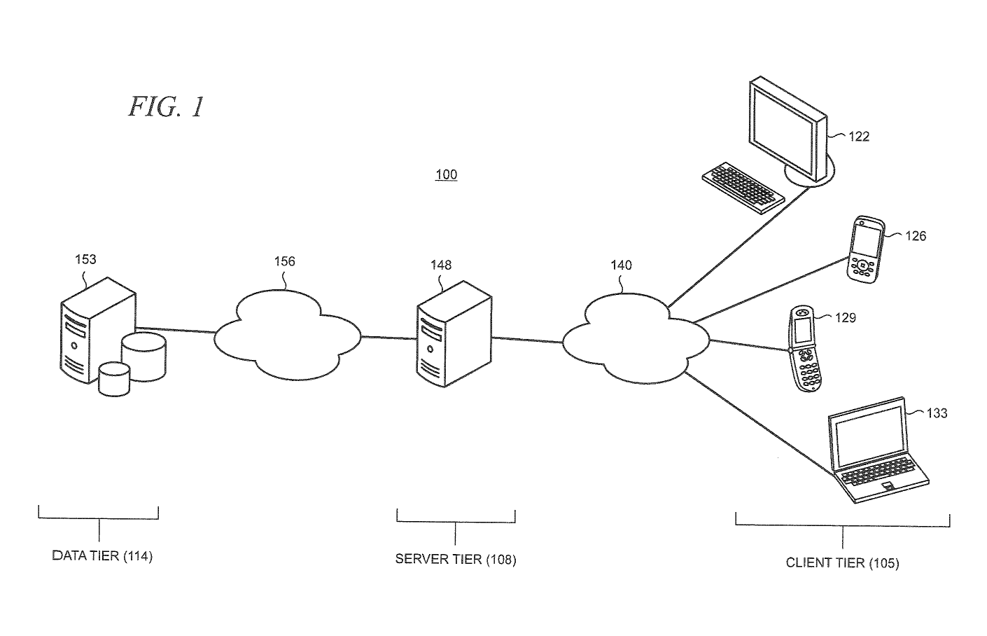

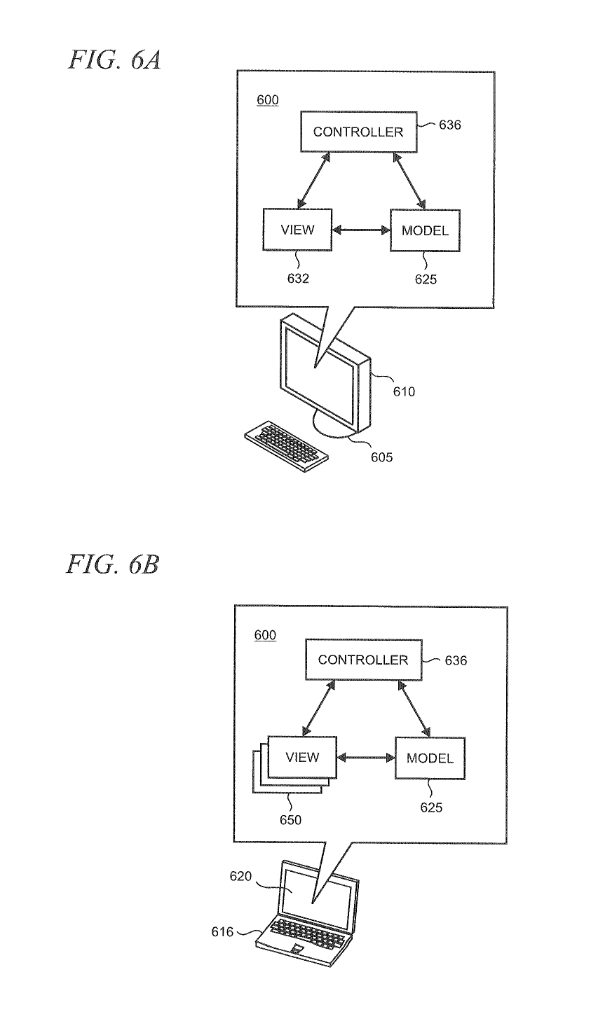

FIG. 1 shows an illustrative computing environment 100 in which the present polymorphic software architecture may be applied. Environment 100 is an example of a typical distributed programming environment in which a multiplicity of tiers are present, each using discrete platforms on which different portions of programming code execute in order to provide a particular experience to an end-user. The tiers include a client tier 105, a server tier 108, and a data tier 114. While environment 100 is typical of many environments that are in use to support common consumer and business computing applications, it is emphasized that the principles embodied by the present polymorphic architecture are applicable to both distributed and non-distributed programming environments. An illustrative non-distributed (i.e., a “monolithic”) programming example is shown in FIGS. 6A and 6B and described in the accompanying text.

In the client tier 105 of the environment 100, a variety of client computing devices are shown which are representative of the kinds of devices with which an end-user typically interacts. These devices include a desktop PC (personal computer) 122, handheld computing device 126 such as a PDA (personal digital assistant), portable media player, game device, smart phone and the like, a mobile phone 129, and a laptop computer 133. While other devices are also contemplated as being usable with the present arrangement, the devices shown in FIG. 1 highlight the fact that such devices can vary widely in terms of characteristics including, for example, processing power, memory, storage, form factor, display size and resolutions, and network connectivity bandwidth.

The server tier 108 is typically communicatively coupled to the client tier 105 using a network 140. While a single network is shown, network 140 may comprise more than one network, each of a different type and using different communication methodologies and/or protocols, in order for the different devices in the client tier 105 to exchange data with the servers in the server tier 108. For example, the desktop PC 122 and laptop PC 133 could be coupled to the server tier 108 via the Internet, while the handheld device 126 and mobile phone could be coupled via a wireless data network such as a GPRS (General Packet Radio Service) or 3G (third generation) network using, for example, HSDPA/UMTS (High Speed Downlink Packet Access/Universal Mobile Telephone System) technology. While the particular network types and protocols utilized can vary among implementations of the present arrangement, it is notable that the performance characteristics of each network, including for example, throughput and latency, will generally be different for each network type and may also vary dynamically in the environment 100.

Server tier 108 includes one or more servers (indicated by a single representative server 148 in FIG. 1). Server 148 may typically be configured as a Web server, but other servers including file servers, transaction servers, and application servers etc., may also be utilized in some implementations of the present polymorphic software architecture. In cases where a data tier 114 is not used, the server 148 could also comprise a database server.

Data tier 114, in this example, includes one or more database servers (indicated by a single representative database server 153). Database server 114 may often be optionally utilized to provide database services to the server tier 108 that might be needed to support a transaction such as that attendant to an online shopping experience for an end-user at the client tier 105, for example. Data tier 114 is coupled to the server tier 108 over a network 156. Network 156 may comprise, for example, a private network, virtual private network (“VPN”), portions of public network infrastructure, or combinations thereof.

While three tiers are shown in FIG. 1, it is emphasized that they are simply illustrative of a commonly utilized computing environment where multiple platforms are utilized to deliver an experience to the end-user. More or fewer tiers can also be utilized with the present polymorphic architecture and the functionality of the tiers and targeted use may differ from that shown. Moreover, with polymorphic architecture, the number of tiers is not necessarily determined upfront, but can be determined at run time, based on the capabilities and constraints of the execution environment. For example, multi-tiered arrangements are commonly used in enterprise networks, web-based service delivery and computing, telecommunications, and mobile data environments.

While actual implementations may vary, the illustrative environment 100 is representative of a distributed computing environment that can generate significant challenges for software architects. Such challenges include dealing with the disparate capabilities of the platforms used in each tier and the different processes and/or computational and data models that run on each platform. In addition, the software architect needs to create solutions that effectively deal with the dynamic behavior of the environment 100 as a whole where end-user activity, network conditions, and program execution can interact to create very complex runtime scenarios.

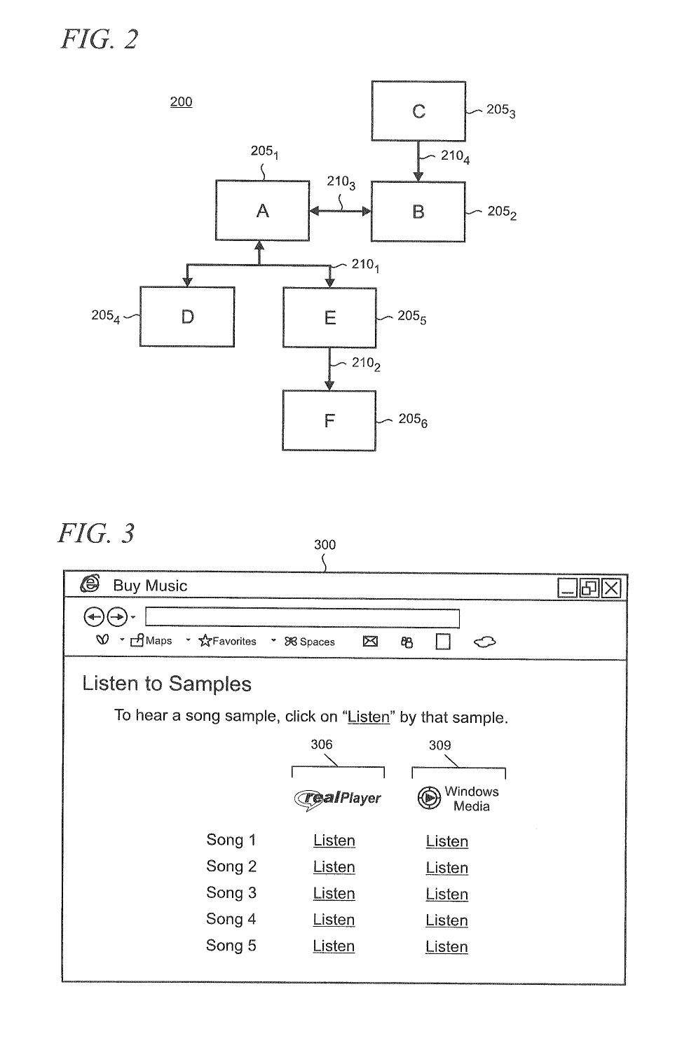

FIG. 2 shows an illustrative software architecture 200 that comprises a multiplicity of software components (which may also be called “elements”) which are functionally connected. Similar to architecture for a building or structure using traditional blueprints, the software architecture 200 provides graphic views or abstractions of the architected system by partitioning features, functionalities, properties, data, or other software objects into discrete components or architectural elements which are shown as boxes. The relationship among the components are typically shown using connectors such as lines, arrows or other symbols. The number of boxes utilized for a given solution and their connected relationships thus determines an overall shape of the architecture. Accordingly, different manifestations of a polymorphic architecture will have different architectures, each generally having a different shape.

In software architecture 200, a number of illustrative boxes 205_{1,2 . . . N} are shown which are functionally connected with arrows 210_{1,2 . . . N} in an arbitrary arrangement. However, it is noted that a variety of symbols, notations, and views may be utilized other than that shown in FIG. 2 to display a particular architecture, including formal notations including, for example UML (Unified Modeling Language), as well as informal notations.

Software architecture 200 may be viewed as a means to define the high level, or strategic design or behavior of a system (as compared with the low level, or detailed design), and as such typically defines the key business drivers, goals, or quality metrics for the system. These high level characteristics include such things as performance, robustness (i.e., fault-tolerance), availability, portability, extensibility, reliability, scalability, security, usability, and similar quality attributes that are often termed the “non-functional requirements” for the system.

Traditionally, software architecture is fixed early on in the design and development process. As it enables or precludes the achievement of non-functional requirements for the system, it has typically been used to direct the processes and tasks required to build the solution from the start of the process. Thus, the views, functional partitioning, functional relationships, and overall design goals embodied in the architecture persist throughout the system's build and into the runtime environment of the software.

In this sense, a traditional architecture can be considered fixed or static, with an invariant shape, essentially from the very beginning of the design process. That is, the architect makes upfront decisions that are embodied in the architecture that carry through to the software's generation of the experience to the end-user at runtime, and the architecture's shape never changes. This upfront decision making needs to accommodate the architect's best estimates as to the environment faced during runtime which can often lead to solutions that are architected in a universal manner so that the software will work across a variety of systems and under wide-ranging conditions. While satisfactory solutions may be achieved with these traditional fixed architectures, they tend to be compromised since they tend to target the least common denominators, in terms of either systems or conditions that are expected to be faced in a given environment.

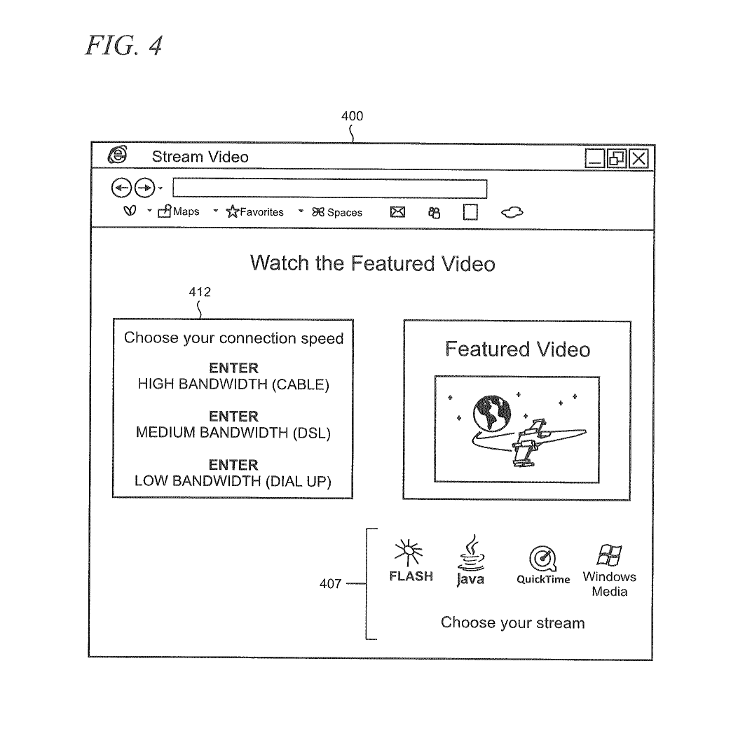

FIGS. 3 and 4 illustrate how this upfront decision making is commonly embodied in an experience for an end-user. FIG. 3 is a screen shot 300 of an illustrative user interface displayed by a Web browser by which an end-user may select an architecture component during runtime of a particular software solution. In this example, the end-user can pick between two different media players, indicated by reference numerals 306 and 309, to listen to samples of songs that are available for download from a website. The software architecture that drives the user interface would be designed with the expectation that the end-user would choose the architectural component, in this case the media player, which would provide the richest end-user experience.

FIG. 4 is a screen shot 400 of another example of a user interface supported by a browser. In this example, the end-user selects not only an architecture component in the form of the media player stream (indicated by reference numeral 407), but can also make another selection that is responsive to the resources in the end-user's environment, in terms of available bandwidth. As indicated by reference numeral 412, the end-user is presented with options for network connection speed (i.e., low, medium and high). As with the choice of player, the provisioning of the bandwidth selection option is included as part of the software architect's up front decision to accommodate some degree of user input during runtime.

While the examples shown in FIGS. 3 and 4 show user interfaces that allow for end-user selection of various components to thereby achieve a particular goal (e.g., rich user experience that maximizes the utilization of available functionality and resources), it is emphasized that the underlying architecture which contains those components is static. Namely, in FIG. 3 the application's structure is fixed, while the user is responsible for selecting the component (i.e., box in an architecture diagram) that best matches the execution environment. Likewise, in FIG. 4 the shape of the architecture is still fixed, and the user can pick both the component (i.e., box) and communication (i.e., connector) that match their execution environment. In both cases the partitioning of the architecture components, including data and the functional communication among the components, is fixed and does not change during runtime.

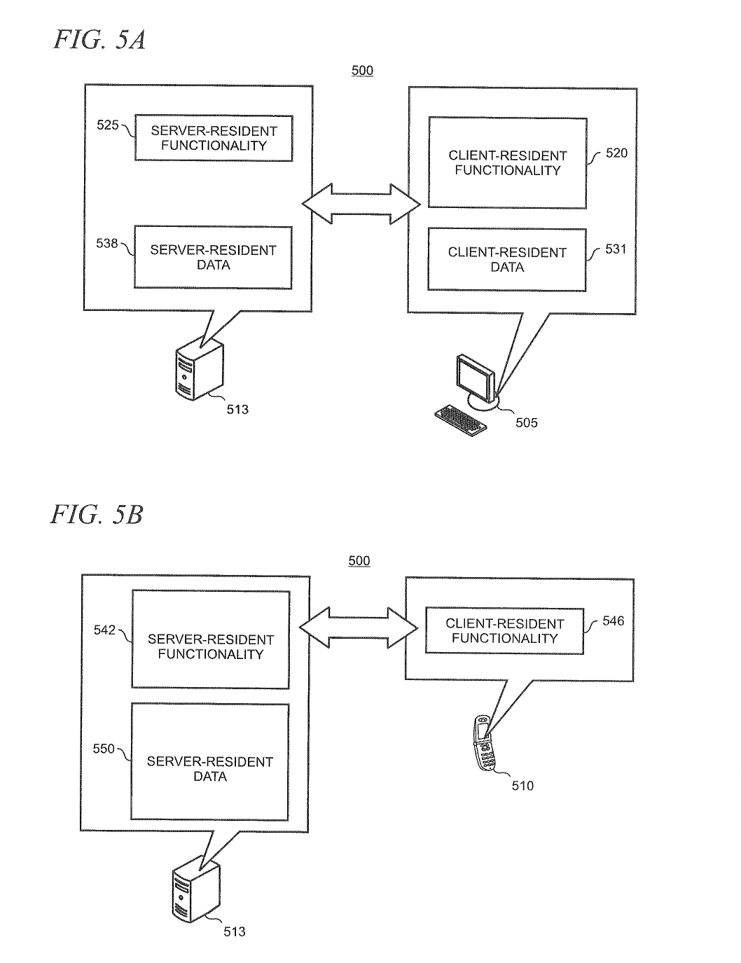

By comparison to a static architecture as shown in FIGS. 2-4 and described in the accompanying text, FIGS. 5A and 5B show an illustrative software architecture 500 that has a dynamically reconfigurable shape with components that may be fused or split in order to meet particular architectural goals. In FIG. 5A, the architecture 500 is shaped for application to a client-server arrangement in which the client is a thick client such as a PC 505. In FIG. 5B, the same architecture 500 is shaped differently for application to a thin client such as a mobile phone 510.

Architecture 500 is thus considered polymorphic as it can take multiple shapes. The partitioning of the components, including in this example both functionality and data, is not fixed early in the design process. Instead, the architecture's shape can be determined much later on at software's build time, or at runtime. In the former case, the polymorphic architecture can be cast in a number of “pre-molded” shapes to accommodate expected conditions in the runtime environment, and in the latter case, the architecture can be fused and/or split on the fly using just-in-time processes to meet requirements in a dynamic manner.

Referring again to FIG. 5A, when dealing with a thick client that has relatively large amounts of capabilities including computational power, memory and storage, the polymorphic architecture 500 splits the functionality of the software between a server 513 and client 505. Note that in FIG. 5A and in the drawings that follow, the size of the boxes in the polymorphic architecture represents a magnitude. Thus, as indicated in FIG. 5A, the splitting point for the functionality in this example is such that there is relatively more client-resident functionality 520 and relatively less server-resident functionality 525, which typically translates into a responsive user interface. However, the data used to support the polymorphic architecture's design goals at runtime is approximately equally split, in this example, between client-resident data 531 and server-resident data 538.

By comparison, as shown in FIG. 5B where the client device has fewer capabilities, the splitting point of the functionality in the polymorphic architecture 500 is handled differently. In this example, it is assumed that the mobile phone 510 has less overall computation power compared with the PC 505, and also has limited storage that is available to software applications (or in some cases, none). Accordingly, the splitting point of the functionality is biased towards placing more functionality as server-resident functionality 542, and less as client-resident functionality 546. This partitioning trades off user interface responsiveness for the ability to run on a wider range of devices. Because the client has limited data storage capabilities, all of the data is fused together, in this example, to reside on the client mobile phone 510 as server-resident data 550.

The profile of the execution environment supported by the client-server arrangement shown in FIGS. 5A and 5B is taken into account when determining the splitting and fusing points for architectural components of the polymorphic architecture 500. This profile may comprise static properties that may be anticipated at design time, such as whether the client device can support a data store. Dynamic properties of the environment that would only be determinable at runtime may also be part of the profile. These dynamic properties may include, for example, network conditions such as throughput and latency, and operating conditions such as load on the server. Several examples of the use of different types of profiles to cast the shape of a polymorphic architecture are provided below.

FIGS. 6A and 6B show an illustrative polymorphic architecture 600 that has its shape cast in view of a profile that takes static properties of the execution environment into account. In this example, a monolithic (i.e., non-distributed) application is utilized where the polymorphic architecture 600 executes on a single platform. As shown in FIG. 6A, architecture 600 executes on a PC 605 that includes a relatively large external display monitor 610. In FIG. 6B, architecture 600 executes on a laptop 616 that includes a relatively small integrated display 620. In addition to the differences in terms of display size, the PC 605 and laptop 616 can typically be expected to use graphic hardware that differs, for example, in display resolution and in the numbers of colors that are supported.

Architecture 600 includes several components to support a graphical user interface (“GUI”) that is supported by the display. These include a model-view-controller architectural pattern as respectively indicated by reference numerals 625, 632, and 636 in FIG. 6A. The model-view-controller isolates data (i.e., the model) from the user interface (i.e., the view) so that changes in the user interface will not impact data handling and vice versa. The separation of these functions is managed by the controller which acts as an intermediary. Accordingly, the view portion of architecture 600 will change as different screens of information are painted onto the display.

FIG. 6A shows a single view 632 that could, for example, support a large number of user controls such as icons, check boxes, text boxes, and the like that are arranged for display on monitor 610 as one screen of information. By comparison, because the integrated display on the laptop 616 is smaller than the PC's monitor, the same screen of information would not be displayable in a readable manner. To deal with the different platform capabilities, architecture 600 is recast with a different shape as shown in FIG. 6B where multiple views (collectively indicated by reference numeral 650) are utilized. Each of the views 650 works as a subview of the single view used by the large monitor 610 so that, for example, three screens of information are used by the laptop 616 to duplicate what is shown using a single screen by the PC 605.

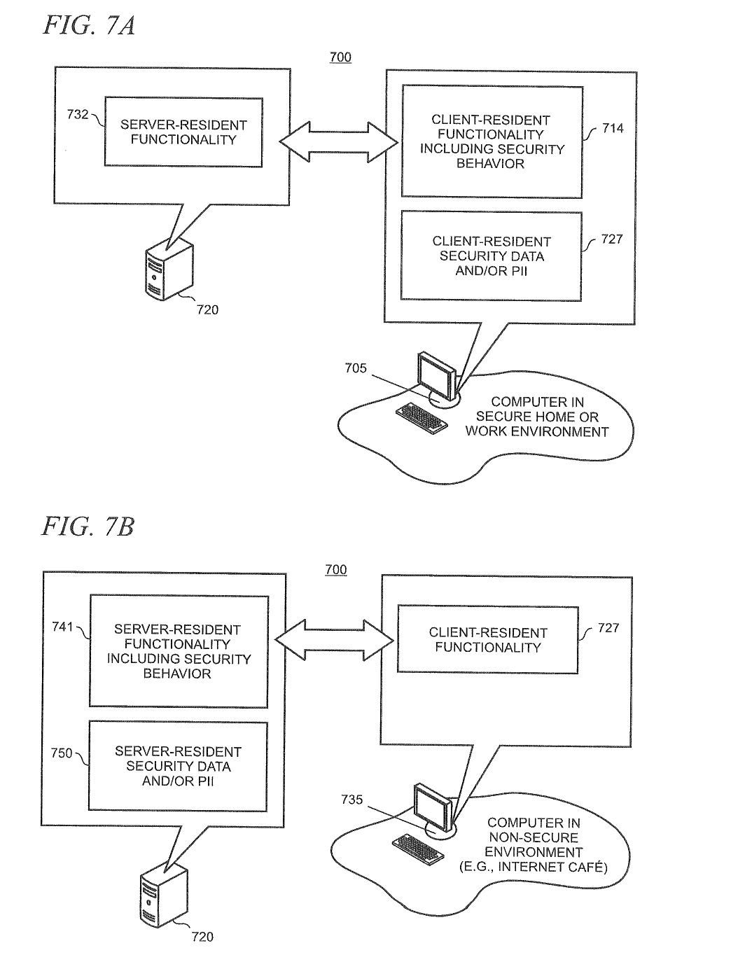

FIGS. 7A and 7B show an illustrative polymorphic architecture 700 that is applicable to a client-server arrangement. The shape of the polymorphic architecture 700 is cast in view of a profile that takes into account static properties which, in this example, is environment security. FIG. 7A shows the polymorphic architecture shape that is applicable to a client-server arrangement when the client PC 705 operates in a secure environment such as that provided by a home or office setting. In FIG. 7B, the architecture 700 is shaped for application to a client PC 735 that operates in a non-secure environment such as that encountered in a public location like an Internet cafe or public library.

When in a secure environment, the splitting point of the polymorphic architecture 700 places relatively more functionality and data in the client PC 705, as shown by reference numeral 714, as compared to the server 720. This functionality further includes behavior that is appropriate to a more secure environment. The rationale behind such a splitting point is that the client PC 705, by virtue of its location in a secure environment, can be trusted as complying with certain security rules so more functionality can thus be pushed into it. A similar justification can be made for pushing security data and/or personally identifiable information (“PII”) into the client PC 705, as indicated by reference numeral 727. Accordingly, the splitting point keeps the server-resident functionality 732 relatively small.

By comparison, as shown in FIG. 7B where the client PC 735 operates in a non-secure environment, the splitting point for both functionality and data is different from that shown in FIG. 7A so that the polymorphic architecture 700 takes a different shape. As it is not desirable to move sensitive data or PII into the client PC 735, or enable it with certain behaviors that are inappropriate to the non-secure environment, client-resident functionality 730 is reduced and more functionality and behavior is pushed into the server 720, as indicated by reference numeral 741. In addition, no security data or PII is kept resident in the client PC 735, and instead it is all pushed to the server 720 as server-resident data 750.

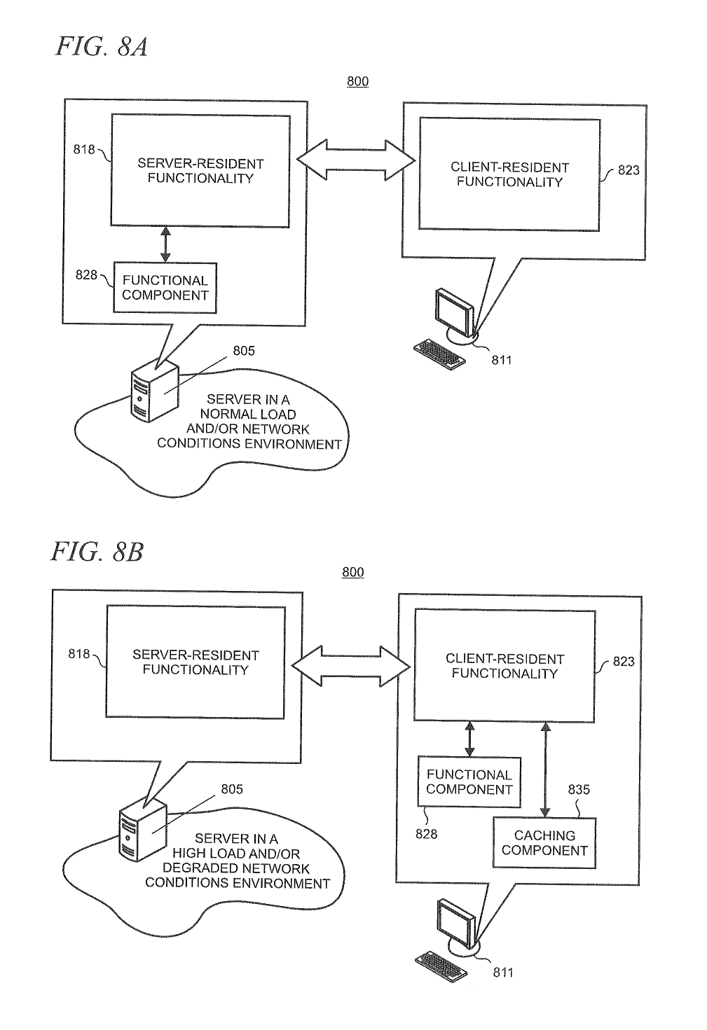

FIGS. 8A and 8B show an illustrative polymorphic architecture 800 that is applicable to a client-server arrangement. The shape of the polymorphic architecture 800 is cast in view of a profile that takes into account dynamic properties of the runtime environment which, in this example, include server load and network conditions such as latency and throughput. FIG. 8A shows the polymorphic architecture shape that is applicable to a client-server arrangement when the server 805 operates in its normal operating environment as far as server load and network conditions. In FIG. 8B, the polymorphic architecture 800 is shaped for application to the server 805 when operating in an environment where the server load is relatively high compared to normal (thus increasing the response time) and/or the network conditions have degraded so that latency is high, or throughput is low.

In the normal operating environment, as shown in FIG. 8A, the splitting point for the polymorphic architecture 800, in this example, places substantially equal amounts of functionality in the server 805 and client PC 811 as respectively indicated by reference numerals 818 and 823. In addition, a particular functional component 828 of the polymorphic architecture 800 is shown as being resident on the server. While the function of the component 828 is arbitrary in this example, it is assumed that it is generally preferable to have it execute on the server 805 under normal operating conditions.

By comparison, as shown in FIG. 8B, when the server 805 is operating under high load or the network between the server 805 and client PC 811 is exhibiting signs of degradation such as high latency or low throughput, the polymorphic architecture 800 changes its shape in response to these conditions. For example, when the server load reaches some threshold, the architecture morphs into a new shape, shuttling functional component 828 from the server 805 to the client PC 811 for execution there. While execution of the component 828 on the client PC 811 would be non-optimal when server load is normal, splitting it from the architecture on the server and fusing it to the functionality on the client creates an optimized structure when the server load is high in this example. In a similar manner, a caching component 835 is fused to the client-resident functionality 823 when the network latency reaches some set threshold so as to produce an optimized structure for degraded network conditions.

It is emphasized that the illustrative conditions such as server load and network latency/throughput are typically subject to highly dynamic behavior. As a result, it can be expected that the polymorphic architecture 800 can change its shape dynamically during runtime to adaptively deal with these changing conditions.

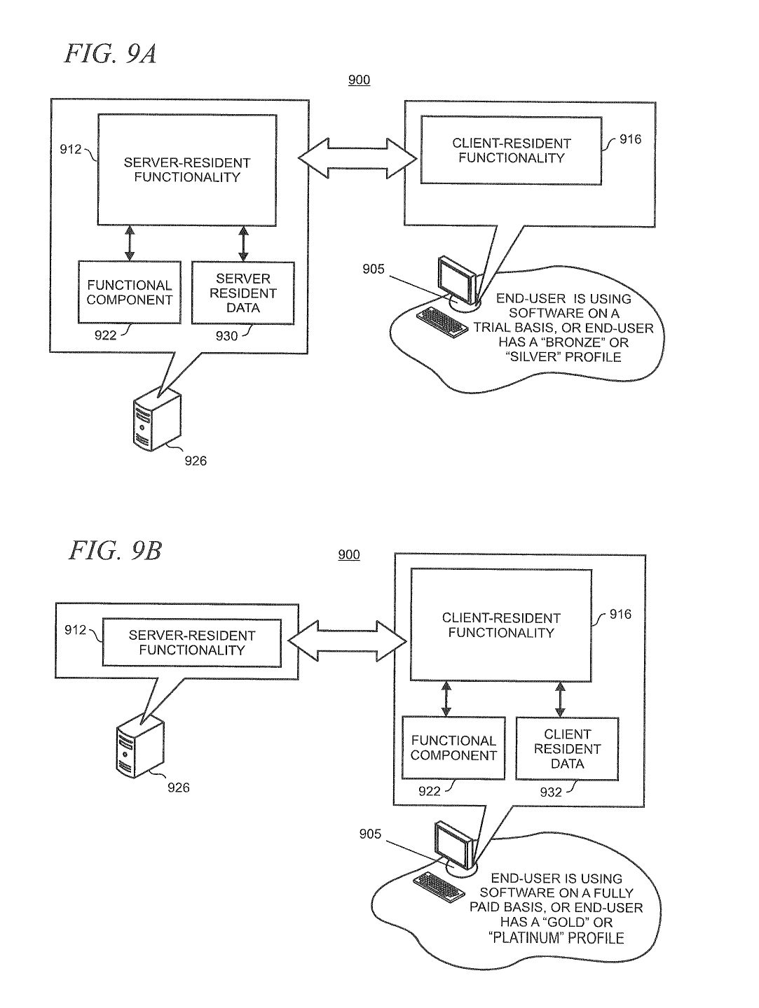

FIGS. 9A and 9B show an illustrative polymorphic architecture 900 that is applicable to a client-server arrangement. The shape of the polymorphic architecture 900 is cast in view of a profile that takes into account business-case characteristics associated with the delivery of a particular software solution to the end-user. For example, the profile considers whether the software is being used on a trial or paying basis, or if the user is a subscriber to a service, and if so to what level of service (e.g., a “bronze,” “silver,” “gold,” or “platinum” level subscriber where each successive tier connotes a higher quality of service with greater access or privileges, or one having a richer feature set, for example).

FIG. 9A shows the polymorphic architecture shape that is applicable to the client-server arrangement when the client PC 905 is running software on a trial basis, or when the end-user is using a service at a lower tiered subscription level (for example, the end-user is a lower level bronze or silver level subscriber which carries relatively fewer rights and privileges). In this example, the split is configured to so that the server-resident functionality 912 is relatively large while the client-resident functionality 916 is kept relatively small. In addition, a particular functional component 922 is fused to the server-resident functionality. This particular architectural shape which favors server-resident functionality could be justified in cases where overall functionality of the software or the user experience is intended to be limited or controlled. In such a case, the supplier may be more able to effectively implement such limitations and controls when more architectural components execute on the server 926.

In addition to functionality being biased towards being server-resident, the fusing point for the data in the environment also leaves it on the server 926 as server-resident data 930. The supplier of the software may wish to engage in some form of data-mining attendant to the software being used on a trial basis or as a non-premium service.

By comparison, as shown in FIG. 9B, when the profile indicates that the end-user is not a trial user, but a fully paid licensee, then the polymorphic architecture 900 has a different shape. The same may also be true when the end-user is a subscriber to a service, for example, at a higher service level such as gold or platinum. In this example, the client-resident functionality 916 increases while the server-resident functionality 912 diminishes. In addition, the functional component 922 is split from the server-resident functionality 912 and fused to the client-resident functionality 916. As noted above, such functionality is arbitrary in this example, although it could represent additional functionality that is provided to end-users of the full-versioned software, or at higher service levels, for example, by embodying a personalization engine that enables the end-user to customize the user experience provided by the software.

In addition to the functional component being shuttled to the client PC 905 from the server 926, the data is removed from the server 926 and resides solely on the client PC 905 as client-resident data 932. This architecture shape change would typically be implemented to meet end-user expectations that data will not be subject to data-mining or other techniques when software is purchased or used at a premium subscription level.

It is emphasized that while the description above and accompanying drawings show a variety of illustrative polymorphic architecture shapes, the principles of polymorphic architecture should not be viewed as being limited to solely those examples. And, although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A method for implementing a polymorphic software architecture in a runtime environment, the method comprising the steps of:
partitioning software among a plurality of architectural elements each of the architectural elements including at least one of functionality, communication between architectural elements, or data;
splitting architectural elements from a portion of the polymorphic software architecture along at least one split point to generate a polymorphic architecture shape;
fusing architectural elements to the portion of the polymorphic software architecture along at least one fusing point to generate the polymorphic shape; and
creating a profile of the runtime environment, the profile being usable to determine the splitting point and the fusing point.

2. The method of claim 1 including a further step of generating a pre-molded shape for the polymorphic software architecture that is deployable at build time of the software.

3. The method of claim 2 including a further step of performing the splitting and fusing in a dynamic manner responsively to changes in the runtime environment.

4. The method of claim 3 in which the polymorphic software architecture is operable over a plurality of discrete tiers and including a further step of implementing the splitting and fusing across tier boundaries.

5. The method of claim 4 in which the profile is created using static properties of the runtime environment, the static properties including ones of capabilities of the platform, business-case information, or end-user profile.

6. The method of claim 5 in which the profile is created using dynamic properties of the runtime environment, including those associated with a server, or communication between architectural elements.

7. The method of claim 6 in which the dynamic properties include at least one of platform loading or network conditions that exist between tiers.

8. A method for generating a shape for software architecture, the method comprising the steps of:
determining one or more characteristics of a runtime environment in which the software architecture is operating;
splitting architectural elements from a portion of the software architecture along predetermined splitting points to address some non-functional requirements of the software architecture responsively to the one or more characteristics;
fusing architectural elements to a portion of the software architecture along predetermined fusing points to address some non-functional requirements of the software architecture responsively to the one or more characteristics; and
executing software in architectural elements after the software architecture is shaped by the splitting and fusing.

9. The method of claim 8 including a further step of shuttling at least one architectural element across a boundary of a distributed computing environment, the shuttling being effectuated when the architectural element is dynamically split from one portion of the software architecture and fused to another portion of the software architecture.

10. The method of claim 9 in which the distributed computing environment is implemented using a multi-tiered computing structure.

11. The method of claim 10 in which the multi-tiered computing structure includes one of client-server topology, peer-to-peer topology, or layered topology.

12. The method of claim 11 in which each tier of the multi-tiered computing structure is defined by one of platform, processes run thereon, or computational model.

13. The method of claim 12 in which tiers in the multi-tiered computing structure are interoperable over one or more networks.

14. The method of claim 13 in which the characteristics comprise conditions including throughput and latency of the one or more networks.

15. The method of claim 14 in which the characteristics comprise static properties of at least one computing platform in the multi-tiered computing platform.

16. A method of developing an architecture for software operable in a runtime environment, the method comprising the steps of:
partitioning software among a plurality of architectural elements, each of the elements including at least one of functionality, communication between architectural elements, or data;
setting a plurality of predetermined splitting and fusing points among the architecture elements, the splitting and fusing points being usable to define a shape of the architecture that is cast during execution of the software in a runtime environment; and
enabling the architecture with polymorphic behavior so that the architecture may be dynamically reshaped along the predetermined splitting and fusing points in response to conditions in the runtime environment.

17. The method of claim 16 including a further step of setting ones of the plurality of predetermined splitting and fusing points across tiers of a distributed computing model.

18. The method of claim 17 in which the conditions include at least one of network latency, network throughput, server loading, computational power, memory, storage, end-user profile, business-case factors, software type including trial version or full version, subscription level, or trust boundaries.

19. The method of claim 18 in which the partitioning is performed to meet non-functional requirements for the software.

20. The method of claim 19 in which the conditions include a service level associated with an end-user, the service level being one of tiered services in which successive tiers are associated with a different quality of service.
